(19) United States
(12) Patent Application Publication
(10) Pub. No.: US 2007/0091914 A1
(43) Pub. Date: Apr. 26, 2007

(54) Secure transfer of data

(76) Inventor: Alexis S R Ashley, Redhill (GB)

Correspondence Address: PHILIPS INTELLECTUAL PROPERTY & STANDARDS, P.O. BOX 3001, BRIARCLIFF MANOR, NY, 10510, US

(21) Appl. No.: 10/559,053

(22) PCT Filed: May 28, 2004
(86) PCT No.: PCT/IB04/01808

§ 371 Date: Dec. 1, 2005

(30) Foreign Application Priority Data
Jun. 5, 2003 (GB) 0312877.4

(51) Int. Cl. H04J 3/02

(52) U.S. Cl. 370/462; 370/401

(57) ABSTRACT

A system for enabling secure transfer of data comprises a receiving device (10) for transmitting a request for data to a sending device (12), a sending device (12) for receiving the request for data and for transmitting the data encrypted with a first key (14) to the receiving device (10), and a server (16) for receiving the encrypted data and identification information from the receiving device (10), the server arranged for partially decrypting the data with a second key (18), and transmitting the partially decrypted data to the receiving device. The receiving device (10) is arranged to decrypt the partially decrypted data received from the server (16) with a third key (20).

This invention relates to a system, method and device for enabling secure transfer of data.

The secure transfer of data such as content is an important feature of many systems that allow access to data. To preserve the rights of any copyright owner, it is necessary to protect content (such as audio-visual material, audio, or still pictures) in a manner that prevents its widespread distribution to people who have not been given the, right to use the content.

Currently the distribution of content is split into two “worlds”. The first “world” is the broadcast world. This typically consists of a company who buys rights to show programmes (or produces those programmes themselves) and broadcasts them to a selected audience. This audience is normally geographically based (for example the UK) because when rights to programmes are bought, they are usually geographically restricted. Another typical feature of this audience is a requirement to have paid the broadcaster for access to the service.

There are two main techniques used to enforce the selectivity of the audience. The first one is based on reception—only the selected audience is capable of receiving the radio transmissions. This is a very simple way of providing the geographic restriction, and is typical of a terrestrial or cable transmission system. The second technique is to use a conditional access (CA) system, which uses cryptographic techniques to ensure that only paid subscribers are able to decrypt the broadcaster's transmission. Typically these CA systems are proprietary, where both the encryption system and the encryption secrets are closely guarded pieces of information.

The second “world” is the Internet based peer-to-peer content sharing world. This world is characterised by the ability to search computers all around the world for content. The vast majority of this content has been made available without the consent of the copyright owner. There are many examples of protocols for peer-to-peer sharing, such as Napster, Gnutella, Freenet, Morpheus and JXTA.

An interesting feature of the JXTA protocol is that it has a concept of groups of users. To join a JXTA group, the user's computer has to contact a membership service on another computer. These two computers then negotiate joining the group. Once a user is a member of a group, they gain the ability to use services only available to this group, such as the ability to search for content within the group.

At the present time there is a need for a system that allows the secure transfer of data such as content over networks such as the Internet, but is nevertheless easy and simple to use and does not create obstacles to the access to content that a user is lawfully allowed to access.

According to a first aspect of the present invention, there is provided a system for enabling secure transfer of data comprising a receiving device for transmitting a request for data, a sending device for receiving the request for data and for transmitting the data encrypted with a first key, and a server for receiving the data and identification information, for partially decrypting the data with a second key, and for transmitting the partially decrypted data.

According to a second aspect of the present invention, there is provided a method for enabling secure transfer of data comprising transmitting a request for data, receiving the data encrypted with a first key, transmitting the data and identification information, receiving the data partially decrypted with a second key, and decrypting the data with a third key.

According to a third aspect of the present invention, there is provided a device for enabling secure transfer of data comprising a network interface for transmitting a request for data, for receiving the data encrypted with a first key, for transmitting the data and identification information, and for receiving the data partially decrypted with a second key, and a processor for controlling the network interface, and for decrypting the data with a third key.

Owing to the invention, it is possible to transfer data securely between devices, the transfer of the data being authenticated by a third party server. The receiving device cannot decrypt the transferred data without possessing appropriate identification information.

Advantageously, the data comprises a session key for decrypting content and the identification information comprises a group membership identifier. In this way, the receiving device must have the appropriate group authentication and it can therefore fully decrypt the transferred data, being a session key to decrypt the transferred content.

In the system, preferably, the receiving device is arranged to receive the data from the sending device and to retransmit the data with the identification information to the server and the receiving device is arranged to decrypt the partially decrypted data received from the server with a third key. Advantageously, the server is arranged to generate the first, second and third keys and to securely transmit the first key to the sending device and to securely transmit the third key to the receiving device.

In the preferred embodiment, the receiving device, the sending device and the server are remotely located from one another and are each connected to a wide area network, such as the Internet

This proposal is based on the idea that normally content is not destined for one individual, there are normally many people who all share the same set of rights to a piece of content. In this proposal these individuals are grouped together, into an entity that can be referred to as a rights group.

There are many advantages to be gained by grouping individuals who share common rights privileges. An example of two such advantages are the ability to use common cryptographic secrets amongst all group members (the advantage is a reduced number of secrets to create and maintain) and members of the group can easily find content they have rights to by only searching within their rights group. The main target for this proposal is in the area of peer-to-peer sharing of content over the Internet. However, all of these techniques are equally applicable in other fields.

Embodiments of the present invention will now be described, by way of example only, with reference to the accompanying drawings, in which:

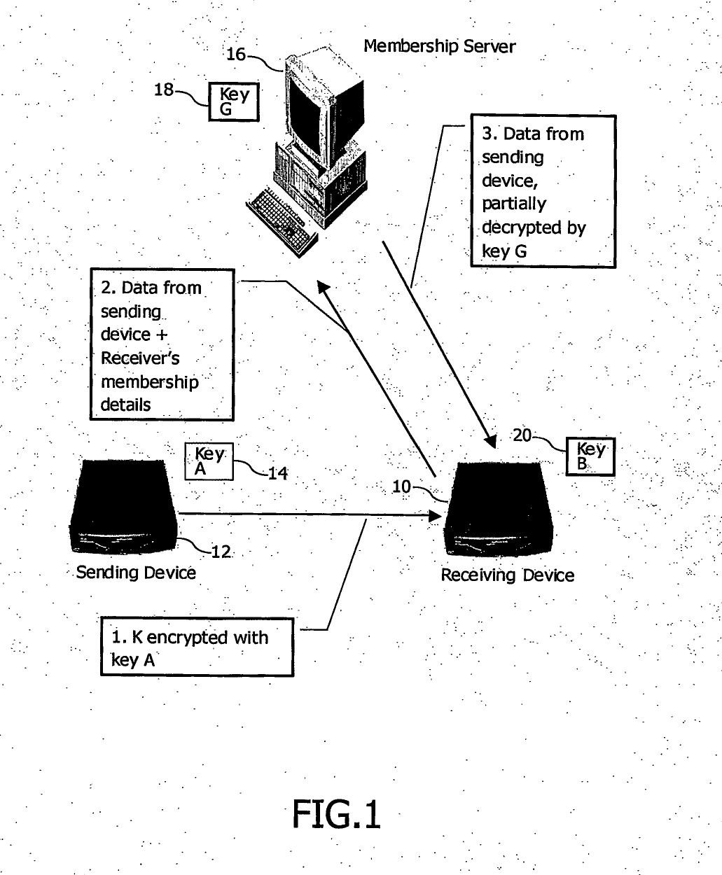

FIG. 1 is a schematic diagram of a system for enabling secure transfer of data,

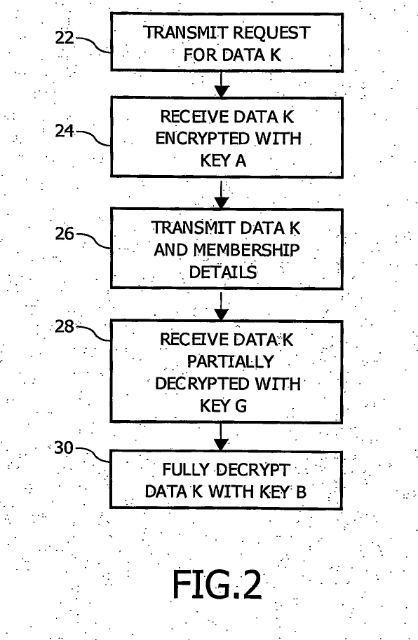

FIG. 2 is a flow diagram of a method for enabling secure transfer of data, and

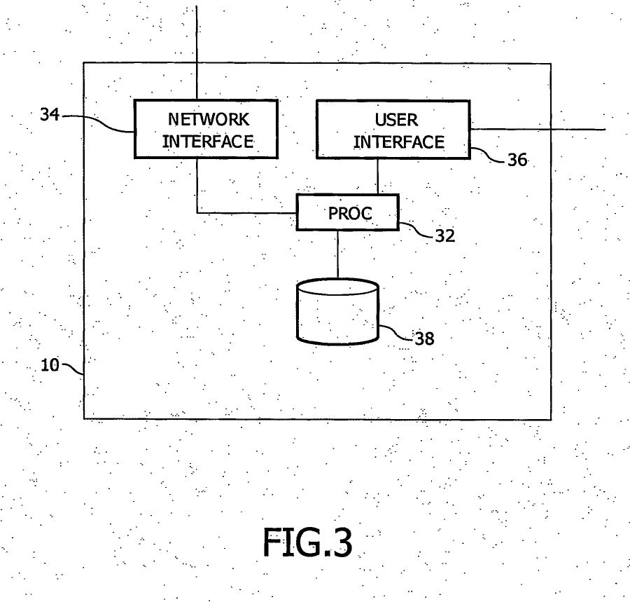

FIG. 3 is a schematic diagram of a device for enabling secure transfer of data, for use in the system of FIG. 1.

The system of FIG. 1 is a system for enabling secure transfer of data, and comprises a receiving device 10, a sending device 12 and a server 16. The receiving device 10, the sending device 12 and the server 16 are remotely located from one another and are each connected to a wide area network, such as the Internet. The receiving device is shown as a digital television receiver 10, although equally it could be a personal computer (PC). Likewise the sending device 12 is shown as a digital television receiver 12. The server 16 is shown as a PC. Each of these devices can send and receive communications and data via the wide area network.

The receiving device 10 (shown in more detail in FIG. 3 and discussed in more detail below) is for transmitting a request for data, the data comprising a session key for decrypting content. The user of the receiving device 10 wishes to have access to a particular piece of content, for example, a new film. In order to access the film, the user of the receiving device 10 needs to obtain the encrypted version of the film (which is assumed to be freely available) and the session key that decrypts the encrypted content. The user can only obtain the data (the session key) if they belong to an appropriate rights group, either by virtue of their location or by virtue of paying an appropriate subscription to belong to the group.

The sending device 12 is for receiving the request for data and for transmitting the data encrypted with a first key 14. The sending device 12 is assumed to belong to the same rights group as the receiving device 10 and so sends the session key encrypted with the key A. The sending device 10 responds to the request for data without authenticating the requesting device, as the system is so arranged that if the requesting device does not belong to the same rights group as the sending device 12 then the system will prevent the decryption of the session key at the server stage.

The receiving device 10 is arranged to receive the data from the sending device 12 and to retransmit the data with the identification information to the server 16. The identification information comprises a group membership identifier, and the server 16 is a membership server for receiving the data and identification information, for partially decrypting the data with a second key 18, and for transmitting the partially decrypted data back to the receiving device 10. The server 16 only carries out its partial decrypt if it is able to authenticate the identification information supplied by the receiving device 10.

The receiving device 10, upon receipt of the data from the server 16, is arranged to decrypt the partially decrypted data received from the server 16 with a third key 20. In this way, the user of the receiving device 10 has access to the required session key to decrypt the content that they wish to access.

In order to obtain the keys used in the system, the server 16 is arranged to generate the first, second and third keys 14, 18 and 20 and to securely transmit the first key 14 to the sending device 12 and to securely transmit the third key 20 to the receiving device 10.

This method of the system effectively uses a generalisation of public key cryptography. In conventional public key cryptography there are two keys, one of which is kept private and one of which is made public. The choice of which key to keep private, and which key to make public is arbitrary.

The generalisation of this system is to have ‘n’ keys. A message encrypted with ‘a’ keys will need all the other keys (i.e. n-a keys) in order to decrypt it. For the system of FIG. 1 three keys (‘A’, ‘B’ and ‘G’) are used. The group membership server 16 keeps one key, and one key is kept on each device 10 and 12. For the purposes of illustration, we shall specify that the sending device 10 has key ‘A’, the receiving device 12 has key ‘B’ and the group membership server 16 has key ‘G’. It is assumed that some secure mechanism was used to transfer the keys ‘A’ and ‘B’ to each device 10 and 12, although it is possible to use an insecure link.

When content is stored on any device, a random session key was used. This session key was encrypted using some unspecified system and then stored. When the two devices (“sender” and “receiver”) wish to transfer a session key, the following steps take place:

The sending device 12 loads the session key from its disk (removing the encryption used during storage) and encrypts this using key ‘A’.
K=session key
C=P_{A}(K)

The encrypted session key is sent to the receiving device 10. The receiving device 10 cannot decrypt this message, because it does not have the other two keys. To be able to decrypt this message, it needs to contact the membership server 16. The receiving device 10 sends the message it just received to the membership server 16, along with information about the receiving device 10.

The membership server 16 checks the information about the receiving device 10 (to be sure it is a member of the group) and if everything is ok, it partially decrypts the message using its key.
C′=P⁻¹_{G}(C)

The group server 16 then returns this to the receiving device, which can now use its key to complete the decryption process
K=P⁻¹_{B}(C′)

FIG. 2 illustrates the method steps executed by the receiving device 12. The method, which is for enabling secure transfer of data, comprises transmitting 22 the request for data, receiving 24 the data encrypted with the first key 14, transmitting 26 the data and identification information, receiving 28 the data partially decrypted with the second key 18, and decrypting 30 the data with the third key 20. As discussed above, the data comprises a session key for decrypting content, and the identification information comprises a group membership identifier.

FIG. 3 illustrates the receiving device 10 in more detail. The device comprises a network interface 34 for transmitting the request for data, for receiving the data encrypted with the first key 14, for transmitting the data and identification information, and for receiving the data partially decrypted with the second key 18, and a processor 32 for controlling the network interface 34, and for decrypting the data with the third key 20.

The receiving device 10 further comprises a storage device 38 for storing the data, and a user interface 36 for receiving the request for data from a user.

The system is so arranged that the receiving device 10 is only able to obtain the session keys for content for which it has the correct group membership. If the device makes a request for a session key that it is not entitled to, then, even though it will receive the encrypted session key, it will not be able to decrypt the key because the receiving device 10 will not be able to supply the correct identification information to the membership server 16. The server 16 will only do the partial decryption of the data if it receives the correct group identification. This ensures that the receiving device 10 is properly authenticated, before the server 16 passes any data back to the receiving device 10.

The system is set up so that no data is ever sent via a public network that is unencrypted. Even though the server 16 transmits the data to the receiving device 10 in a partially decrypted form, only the receiving device 10 can complete the decryption with the key 20. The system therefore provides a way of transferring data between devices, only when the requesting device is properly authenticated.

1. A system for enabling secure transfer of data comprising a receiving device (10) for transmitting a request for data, a sending device (12) for receiving the request for data and for transmitting the data encrypted with a first key (14), and a server (16) for receiving the data and identification information, for partially decrypting the data with a second key (18), and for transmitting the partially decrypted data.

2. A system according to claim 1, wherein the receiving device (10) is arranged to receive the data from the sending device (12) and to retransmit the data with the identification information to the server (16).

3. A system according to claim 1, wherein the receiving device (10) is arranged to decrypt the partially decrypted data received from the server (16) with a third key (20).

4. A system according to claim 1, wherein the data comprises a session key for decrypting content.

5. A system according to claim 1, wherein the identification information comprises a group membership identifier.

6. A system according to claim 1, wherein the server (16) is arranged to generate the first, second and third keys (14, 18, 20) and to securely transmit the first key (14) to the sending device (12) and to securely transmit the third key (20) to the receiving device (10).

7. A system according to claim 1, wherein the receiving device (10), the sending device (12) and the server (16) are remotely located from one another and are each connected to a wide area network.

8. A system according to claim 7, wherein the wide area network is the Internet.

9. A method for enabling secure transfer of data comprising transmitting (22) a request for data, receiving (24) the data encrypted with a first key (14), transmitting (26) the data and identification information, receiving (28) the data partially decrypted with a second key (18), and decrypting (30) the data with a third key (20).

10. A method according to claim 9, wherein the data comprises a session key for decrypting content.

11. A method according to claim 9, wherein the identification information comprises a group membership identifier.

12. A device for enabling secure transfer of data comprising a network interface (34) for transmitting a request for data, for receiving the data encrypted with a first key (14), for transmitting the data and identification information, and for receiving the data partially decrypted with a second key (18), and a processor (32) for controlling the network interface (34), and for decrypting the data with a third key (20).

13. A device according to claim 12, and further comprising a storage device (38) for storing the data.

14. A device according to claim 12, and further comprising a user interface (36) for receiving the request data from a user.

15. A device according to claim 12, rein the data comprises a session key for decrypting content.

16. A device according to claim 12, wherein the identification information comprises a group membership identifier.
